(19) United States
(12) Patent Application Publication
(10) Pub. No.: US 2010/0145552 A1
(43) Pub. Date: Jun. 10, 2010

(54) Route planning using ground threat prediction

(75) Inventors: Carl R. Herman, Owego, NY (US); James C. Rosswog, Endicott, NY (US)

Correspondence Address: TAROLLI, SUNDHEIM, COVELL & TUMMINO LLP, 1300 East Ninth Street - Suite 1700, Cleveland, OH, 44114, US

(73) Assignee: Lockheed Martin Corporation

(21) Appl. No.: 12/315,593

(22) Filed: Dec. 4, 2008

(51) Int. Cl. G01C 23/00

(52) U.S. Cl. 701/3

(57) ABSTRACT

Systems and methods are disclosed for determining an optimal flight path for an aircraft through a region of interest. A reroute region, which provides extreme boundaries for an optimal flight path, is defined around an initial flight path for the aircraft. A plurality of subregions are defined within the reroute region. Each of the plurality of subregions represent one of a plurality of representative times at which the airplane is expected to arrive at an associated location on the initial flight path. The position of at least one threat is predicted at each of the plurality of representative times. A cost is assigned to each cell in each subregion according to the predicted position of the at least one threat source at the representative time associated with the subregion. The optimal path is determined as a path through the reroute region having a lowest total cost.

### BACKGROUND OF THE INVENTION

1. Technical Field

The invention relates to systems and methods for planning an optimal route for an aircraft by predicting the location and effectiveness of ground threats.

2. Description of the Prior Art

Aircraft are used in a wide variety of applications, both civilian and military, including travel, transportation, fire fighting, surveillance, and combat. Various aircraft have been designed to fill the wide array of functional roles defined by these applications, including balloons, dirigibles, traditional fixed wing aircraft, flying wings and helicopters. As aircraft have evolved, however, so have techniques and systems for neutralizing the effectiveness of aircraft, including a number of devices that can be employed at ground level to damage an aircraft and its occupants. Given the relatively high visibility of an aircraft in flight from the ground and the structural trade-offs necessary to keep an aircraft at a proper weight for flight, it is often desirable to avoid these threats entirely where possible.

### SUMMARY OF THE INVENTION

In accordance with an aspect of the present invention, a method is provided for determining an optimal flight path for an aircraft through a region of interest. A reroute region, which provides extreme boundaries for an optimal flight path, is defined around an initial flight path for the aircraft. A plurality of subregions are defined within the reroute region. Each of the plurality of subregions represents one of a plurality of representative times at which the airplane is expected to arrive at an associated location on the initial flight path. The position of at least one threat is predicted at each of the plurality of representative times. A cost is assigned to each cell in each subregion according to the predicted position of the at least one threat source at the representative time associated with the subregion. The optimal path is determined as a path through the reroute region having a lowest total cost.

In accordance with another aspect of the present invention, a computer readable medium, storing executable instructions for determining an optimal flight path for an aircraft through a region of interest, is provided. Upon execution of these instructions, a reroute region, which provides extreme boundaries for an optimal flight path, is defined around an initial flight path for the aircraft. A plurality of subregions are defined within the reroute region. Each of the plurality of subregions represents one of a plurality of representative times at which the airplane is expected to arrive at an associated location on the initial flight path. The position of at least one threat is predicted at each of the plurality of representative times. A cost is assigned to each cell in each subregion according to the predicted position of the at least one threat source at the representative time associated with the subregion. The optimal path is determined as a path through the reroute region passing through each of the plurality of subregions that has a lowest total cost.

In accordance with yet another aspect of the present invention, a system is provided for determining an optimal flight path for an aircraft through a region of interest. A map initialization component is configured to define a reroute region, which provides extreme boundaries for an optimal flight path, around an initial flight path for the aircraft and a plurality of subregions within the reroute region. Each of the plurality of subregions represents one of a plurality of representative times at which the airplane is expected to arrive at an associated location on the initial flight path. A threat prediction component is configured to predict the position of at least one threat at each of the plurality of representative times. A cost mapping component is configured to assign a cost to each cell in each subregion according to the predicted position of the at least one threat source at the representative time associated with the subregion and at least one geographical feature of the region of interest. A path optimization component is configured to determine the optimal path as a path through the reroute region having a lowest total cost.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates a system configured to provide an optimal flight path for an aircraft from the predicted location and region of effectiveness for one or more ground level threats in accordance with an aspect of the present invention;

FIG. 2 illustrates an exemplary implementation of a route planning system in accordance with an aspect of the present invention;

FIGS. 3A-3I illustrate graphically the operation of a route planning system in accordance with an aspect of the present invention as a series of maps depicting a region of interest through which the aircraft will pass;

FIG. 4 illustrates a method for determining an optimal flight path for an aircraft through a region of interest in accordance with an aspect of the present invention; and

FIG. 5 illustrates a computer system that can be employed to implement systems and methods described herein, such as based on computer executable instructions running on the computer system.

### DETAILED DESCRIPTION OF THE INVENTION

In accordance with the present invention, a route planning system is provided for determining an optimal route for an aircraft in a hostile region by predicting the location and effectiveness of one or more threats to the aircraft at ground level. During route planning, a reroute zone, consisting of all points through which an aircraft might pass given one or more initial mission parameters, is developed. An initial flight plan for the aircraft can be plotted, and the reroute zone can be divided into a plurality of subzones, with each subzone representing a time in which the aircraft is expected to pass through its associated portion of the reroute zone. The position and one or more effective ranges for each of one or more threats can be determined for each time period, and a cost can be attached to cells within a cost map of the reroute zone based upon the determined position and effective ranges of each threat. From this cost map, an optimal flight plan for the aircraft can be determined.

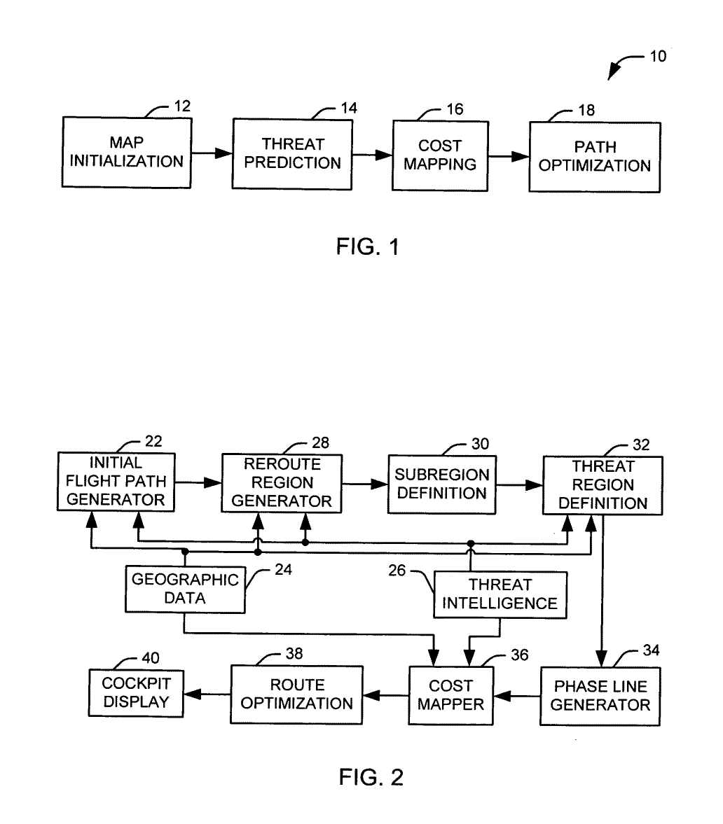

FIG. 1 illustrates a system 10 configured to provide an optimal flight path for an aircraft from the predicted location and region of effectiveness for one or more ground level threats in accordance with an aspect of the present invention. It will be appreciated that each component 12, 14, 16, and 18 of this system can be implemented on the aircraft as part of existing navigation systems or as a stand-alone system connected to the aircraft by a communications link. The system 10 includes a map initialization component 12 that is configured to produce an initial cost map for the aircraft. To this end, one or more flight parameters for the aircraft can be determined, and a reroute region for the aircraft can be determined to encompass all possible locations through which it is possible for the aircraft to travel. For example, the flight path of the aircraft can be limited by time constraints, fuel constraints, geographical features, political boundaries, and regions of significant threat concentration. In the initial cost map, cells within the reroute region can be assigned a default cost value, while regions outside of the reroute region are assigned an infinite cost.

Once the reroute region has been established, the map initialization component can determine an initial flight path and approximate times at which the aircraft would reach each point on the initial flight path. The reroute region can then be divided into subregions, with each subregion representing a range of times along the aircraft's flight path. It will be appreciated that the subregions can overlap, such that a given point within the reroute region can fall within multiple subregions. A representative time for each subregion can be selected from the associated range of times for each subregion. In one implementation, the representative time is the average of the two times at the extreme of the range of times associated with the subregion.

The initial cost map is provided to a threat prediction component 14 that determines a position and one or more effective ranges for one or more ground level threats. For example, a current position, velocity, and direction of travel for each threat can be provided by associated sensor systems. From these parameters, and known geographical details (e.g., road paths, obstructing terrain, etc.), a path of travel for the ground level threats can be predicted. Coupled with the known velocity, a distribution of possible locations of a given threat can be predicted at each representative time associated with one of the subregions. From this distribution and a known range or ranges of the threat, one or more regions in which it is likely the threat is present can be established for each of the representative times.

The projected positions and regions of likely threat can be provided to a cost mapping component 16 that assigns an associated cost to each of a plurality of cells within the reroute zone. In accordance with an aspect of the present invention, the cells for each subregion can be assigned according to the possible positions and effective ranges of each threat at the representative time for that region. Accordingly, each subregion is assigned its associated cost values using a different distribution of possible positions of the threat. Where multiple threat ranges are utilized, each threat range can add a different cost to the cells within the range. The final cost map will be a sum of a plurality of individual cost maps representing the plurality of subregions. From this final cost map, a route planning component 18 can determine an optimal flight plan for the aircraft.

FIG. 2 illustrates an exemplary implementation of a route planning system 20 in accordance with an aspect of the present invention. An initial flight path generator 22 produces an estimated flight path for the aircraft. The initial flight plan can be generated according to any standard method to allow the aircraft to efficiently travel between a starting point and an ending point. For example, the initial flight path can be determined as a straight line path between a designated starting point and a designated ending point, modified to avoid impassable or hazardous terrain. Alternatively, any of a number of known methods can be utilized to take into any of a database of known geographical data 24, including, for example, geographic features and political boundaries, and a database of intelligence on known threats 26, such as the position, concentration, and capabilities of known threats.

The determined initial route is provided to a reroute region generator 28. The reroute generator 28 determines all possible locations through which it is possible for the aircraft to travel given one or more constraints placed on the travel of the aircraft. For example, the potential flight path of the aircraft can be limited by time constraints, fuel constraints, geographical features, political boundaries, and regions of significant threat concentration, and the reroute region can be defined to encompass only those locations in the region of interest that are permissible given these constraints.

The reroute region is provided to a subregion definition component 30 that divides the reroute region into a plurality of subregions representing different times. From the initial flight plan, it can be determined when the aircraft is expected to pass through the region of interest, and the representative times for the plurality of subregions can be selected from that time interval by any appropriate means. For example, a predetermined number of representative times can be selected as to be evenly separated in time across the expected time interval. Once the representative times have been selected, associated subregions can be defined around the positions on the initial flight path associated with that time. In accordance with an aspect of the present invention, it is expected that every point in the reroute region will be contained by at least one of the subregions. In some implementations, the subregions will overlap, such that some points within the reroute region are represented by multiple subregions.

A threat region definition component 32 determines a position and one or more effective ranges for one or more ground level threats, and defines regions in which the threats are expected to be located. For example, a current position, velocity, and direction of travel for each threat can be provided by associated sensor systems. From these parameters, and known geographical details (e.g., road paths, obstructing terrain, etc.), a path of travel for the ground level threats can be predicted. Coupled with the known velocity, a distribution of possible locations of a given threat can be predicted at each representative time associated with one of the subregions. Each threat can be represented by multiple zones, with each zone representing a given range of likelihood that the threat is present within that zone.

A phase line generator 34 is configured to define a boundary on the possible position of the threat at respective representative times. A given phase line is a boundary representing the greatest possible distance that a threat could travel toward the flight path of the aircraft in the time period represented by the phase line. A phase line can be determined for each of a plurality of representative times for each threat from one or more of the current position, direction of motion, and velocity of the threat, known geographical features in the region of interest, and the capabilities of the threat. It will be appreciated that representative times utilized by the phase line generator can be selected to coincide with the representative times for the plurality of subregions.

A cost mapper 36 determines associated cost values for each cell within the reroute region according to the expected position and range of effect of each threat. In accordance with an aspect of the present invention, the cost mapper 36 assigns the cost values individually to each subregion, with the possible position of the threat being constrained by the representative time associated with the subregion. For example, a first subregion can represent a time period centered around eight minutes into the expected flight path of the aircraft. A phase line representing the maximum distance traveled toward the flight path in eight minutes can be applied to the distribution determined by the threat prediction component. Accordingly, the universe of possible positions of the threat at the representative time, for the purpose of computing the cost values for this subregion, is limited to the possible locations of the threat eight minutes into the flight of the aircraft.

Once the modified distribution for the representative time has been determined for a given subregion, appropriate cost values for the subregion can be determined from the modified distribution and known effective ranges for the threat. By effective range, it is meant the range at which the threat is capable of inflicting meaningful damage on the aircraft or its occupants. It will be appreciated that multiple effective ranges can be known for a given threat based, for example, with each effective range representing the possibility of the threat inflicting significant damage on the aircraft. The cost values for the subregion can also be influenced by geographical features of the subregion and intervening terrain. For example, where a region of elevated terrain would block or hinder line of sight to a particular cell within the subregion that is within an effective range of the threat, the imposed cost for that cell can be reduced or eliminated. Further, specific types of terrain can cause a cost to be assessed or removed from a given cell. For example, where the elevation of a cell is higher than it is desirable for the aircraft to fly, a cost can be accessed to that cell. Once appropriate costs have been assigned to each subregion, the costs within overlapping regions can be averaged or summed to provide a final cost value for each cell.

Once each cell within the reroute region has been assigned cost, a lowest cost path for the aircraft can be determined at route optimization component 38. The route optimization performs an appropriate optimization algorithm to determine a lowest cost path for the aircraft through the reroute region. For example, the lowest cost path can be determined by any of a Dijkstra's algorithm, a Bellman-Ford algorithm, an A* search algorithm, a Floyd-Warshall algorithm, or an algorithm based on perturbation theory. Once an optimal flight plan has been determined, the flight path is provided to a pilot of the aircraft on a display 40 within the cockpit.

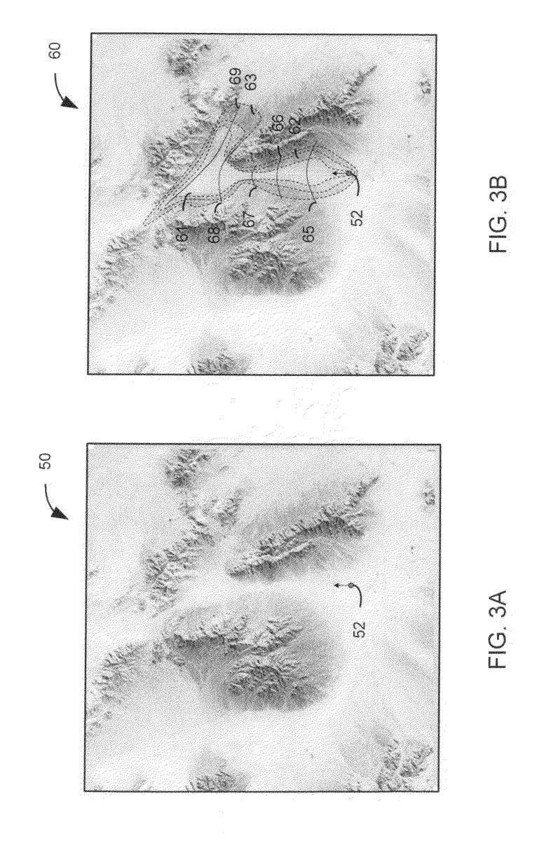

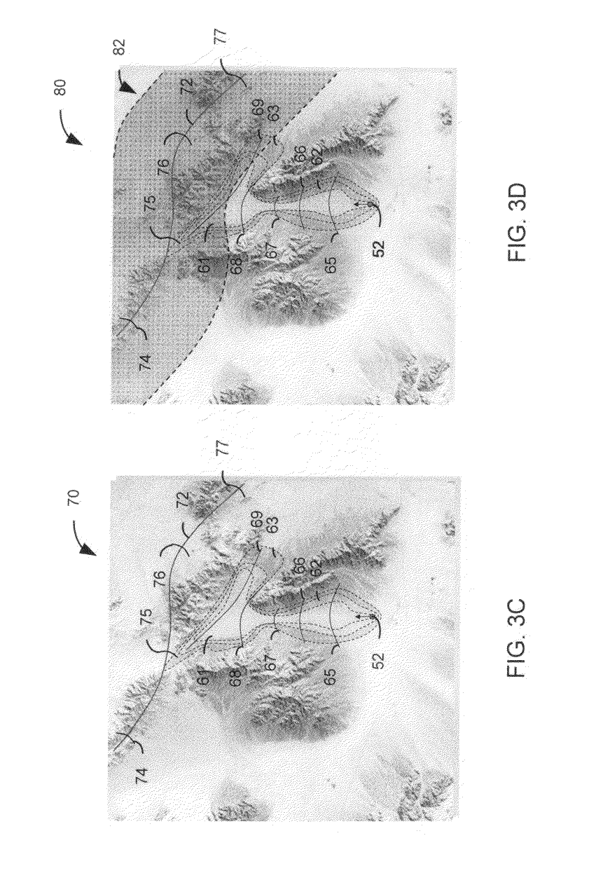

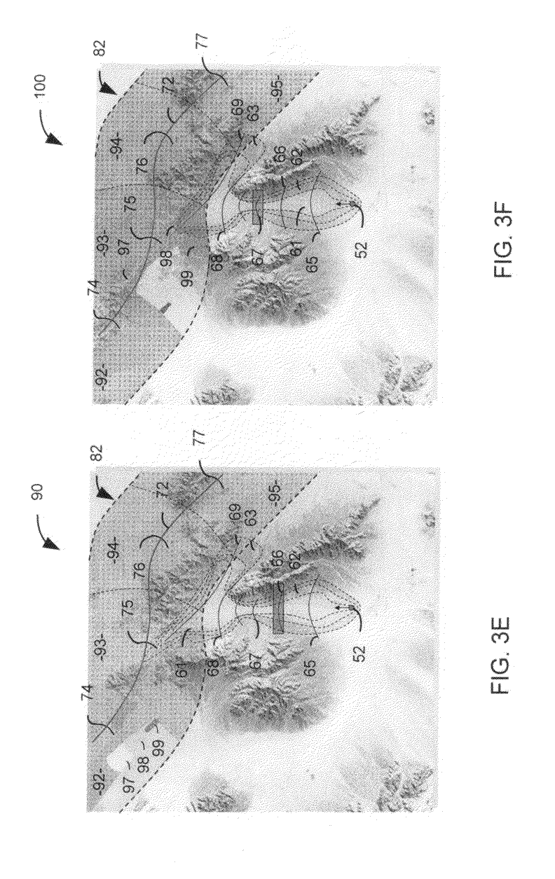

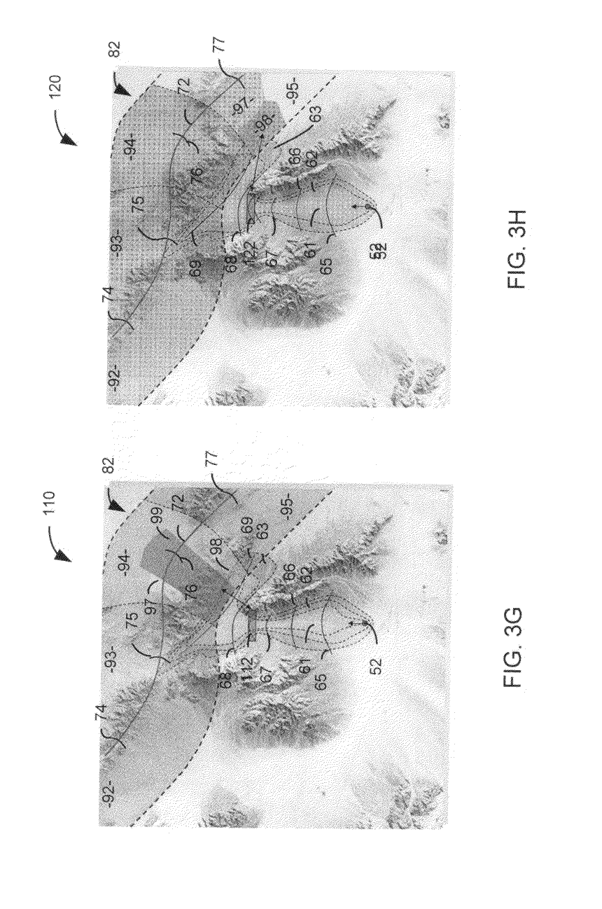

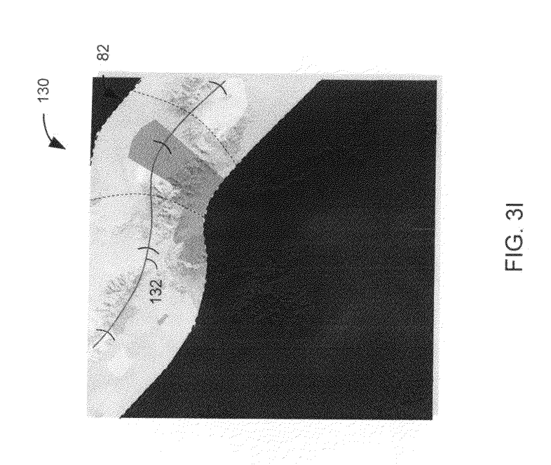

FIGS. 3A-3I illustrate graphically the operation of a route planning system in accordance with an aspect of the present invention as a series of maps 50, 60, 70, 80, 90, 100, 110, 120, and 130 depicting a region of interest through which the aircraft will pass. Each map (e.g., 60) depicts one step of a series of steps in the route planning process, with the number of illustrated elements maintained among steps. It will be appreciated that the illustrated steps are not necessarily inclusive, and that not all steps may be necessary in the operation of a route planning system in accordance with an aspect of the present invention. Further, the steps can take place in an order different than that depicted herein, and can be performed in parallel in some implementations.

FIG. 3A illustrates a first map 50 of the region of interest. In the illustrated region, a ground level threat 52 is illustrated, with a current direction of motion indicated by an associated arrow. FIG. 3B illustrates a second map 60 of the region of interest that indicates probable locations of the threat 52. In accordance with an aspect of the present invention, the future location of the threat can be predicted as one or more probability regions defined around the current position of the threat 52 according to one or more of the current direction of motion of the threat, a current velocity of the threat, known geographical features in the immediate vicinity of the threat, and the capabilities (e.g., maximum velocity, ability to traverse difficult or unconventional terrain, etc.) of the threat.

The probability regions 61-63 represent the portions of the region of interest in which the threat is most likely to remain during a time period of interest. The time period of interest can be, for example, a maximum time necessary for the airplane to pass through the region of interest given the constraints placed on the route planning process. To this end, a first probability region 61 can be defined to represent an area in which the threat 52 is most likely to be located during the time period of interest, such that the threat a second probability region 62 can be defined to represent a broader area in which there is a greater confidence that the threat will be present, and a third probability region 63 can be defined to represent an area in which there is a still greater confidence that the threat is present. Any portion of the map not encompassed by one of the three probability regions is considered to have an insufficient likelihood of containing the threat 52 at any point in the time period of interest to warrant consideration in populating the cost map.

A number of phase lines 65-69 can be defined within the probability regions to indicate a boundary on the position of the threat 52 at respective representative times. As will be appreciated, a threat can travel farther in twenty minutes than five, and thus the universe of possible locations for the threat after five minutes is smaller than the universe of possible locations for the threat after fifteen minutes. The phase lines can be determined for each threat from one or more of the current position, direction of motion, and velocity of the threat, known geographical features in the region of interest, and the capabilities of the threat. A given phase line can be conceptualized as the farthest point that a threat could travel prior to the representative time associated with the phase line.

Each phase line 65-69 represents a progressively larger period of time as the distance of the phase line from the current position of the threat 52 increases. In the illustrated map 60, a first phase line 65 represents a time period of five minutes after the position of the threat 52 has been determined. Accordingly, only that portion of the probability regions 61-63 that falls below (i.e., toward the current location of the threat 52) the first phase line 65 on the map is considered as a feasible location for the threat after five minutes. Similarly, a second phase line 66 represents a period of eight minutes after the position of the threat has been determined, a third phase line 67 represents a ten minute interval, a fourth phase line 68 represents a twenty minute interval, and a fifth phase line 69 represents a twenty-five minute interval.

FIG. 3C illustrates a third map 70 of the region of interest representing an initial flight path 72 for the aircraft. The initial flight path 72 can be generated according to standard methods to allow the aircraft to efficiently travel between a starting point and an ending point. The initial flight path 72 can take into account the current position of known threats, particularly regions of significant threat concentration. Once the flight path 72 has been established, a plurality of expected locations 74-77 can be established for each of a plurality of representative times. In the illustrated map 70, a first expected location 74 represents a time eight minutes after the position of the threat 52 has been determined, a second expected location 75 represents a time ten minutes after the position of the threat has been determined, a third expected location 76 represents a time twelve minutes after the position of the threat has been determined, and a fourth expected location 77 represents a time fourteen minutes after the position of the threat has been determined.

FIG. 3D illustrates a fourth map 80 of the region of interest. In this illustration 80, a reroute region 82 has been defined around the flight path 72 of the aircraft. In accordance with an aspect of the present invention, the reroute region 82 can be defined according to one or more of time constraints, fuel constraints, geographical features, political boundaries, and regions of significant threat concentration. All points within the region of interest that are outside of the reroute region 82 are assigned an infinite cost.

FIG. 3E illustrates a fifth map 90 of the region of interest. In this illustration 90, the reroute region 82 has been divided into a plurality of subregions 92-95. Each of the plurality of subregions 92-95 is defined around an associated expected location 74-77 on the initial flight plan 72, such that each subregion represents a portion of the region of interest in which the aircraft is likely to be present at and around the representative time for the expected location (e.g., 74) associated with the subregion.

In accordance with an aspect of the present invention, the effect of the threat 52 on each subregion can be determined only from the possible position of the threat at the representative time associated with that subregion. For example, the first subregion 92 can have a representative time of eight minutes after the location of the threat 52. Accordingly, the probability regions 61-63 for the threat 52 can be bounded by a phase line, specifically the second phase line 66, corresponding to the representative time.

Limiting the possible position of the threat to this bounded region, costs can be assigned to the first subregion 92 according to the possible positions of the threat and one or more known effective ranges over which the threat can threaten the aircraft. For example, for a given threat, it might be known that the threat has the capacity to do significant damage to the aircraft at a range of five hundred yards. It will be appreciated that multiple ranges might be utilized, as for some threats, the probability that the threat can damage the aircraft will increase with proximity to the aircraft.

Accordingly, from the known threat ranges and the probability regions 61-63 representing the threats position, it is possible to assign costs to the cells within the first subregion 92. For example, if a cell is within the effective range of a location within the third probability region 63, a first cost can be added to the cell, producing a low cost region 97, if the cell is within the effective range of the second probability region 62, an additional second cost can be added to the cell, producing a moderate cost region 98, and if the cell is within the effective range of the first probability region 61, an additional third cost can be added to the cell to produce a high cost region.

It will be appreciated that the cost can be modified due to intervening geographical features or weather conditions that occlude the sightline from the threat to the aircraft. Similarly, the cost can be reduced when effectiveness of the threat is reduced relative to other positions within range of the aircraft. For example, when the target is at a poor angle for targeting the aircraft (e.g., substantially perpendicular to the flight path of the aircraft), its imposed cost can be reduced. It will further be appreciated that cost can be added to a given cell for other reasons as well, such as nearby geographical features or other potential hazards to the aircraft.

Each of FIGS. 3F, 3G, and 3H illustrates the process described for the first subregion 92 for a second subregion 93, a third subregion 94, and a fourth subregion 95, respectively. In FIG. 3F, the map 100 of the region of interest illustrates low 97, moderate 98, and high 99 cost regions for the second subregion 93, which has a representative time of ten minutes after the identification of the threat, such that the probability regions 61-63 are limited by the second phase line 67. In FIG. 3G, the map 110 of the region of interest illustrates low 97, moderate 98, and high 99 cost regions for the third subregion 94, which has a representative time of twelve minutes after the identification of the threat, such that the probability regions 61-63 are limited by a fifth phase line 112 representing this twelve minute period. In FIG. 3H, the map 120 of the region of interest illustrates low 97 and moderate 98 cost regions for the fourth subregion 95, which has a representative time of fourteen minutes after the identification of the threat, such that the probability regions 61-63 are limited by a sixth phase line 122 representing this fourteen minute period.

FIG. 3I illustrates a ninth map 130 of the region of interest. In this illustration 130, cost values have been assigned to the entire reroute region 82 and an optimal flight path 132 through the region of interest has been determined. Once the cost values have been assigned, the optimal path can be determined by an appropriate route planning algorithm. The determined optimal path 132 can then be provided to a pilot on an associated display.

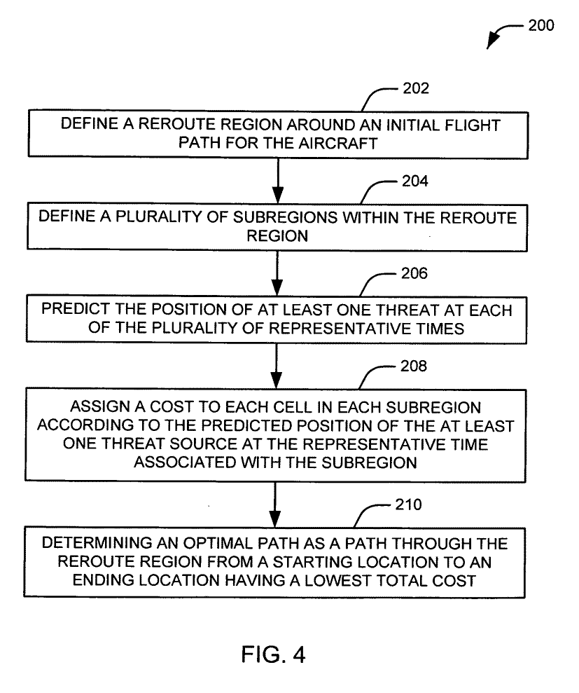

In view of the foregoing structural and functional features described above, a methodology in accordance with various aspects of the present invention will be better appreciated with reference to FIG. 4. While, for purposes of simplicity of explanation, the methodology of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 4 illustrates a method 200 for determining an optimal flight path for an aircraft through a region of interest in accordance with an aspect of the present invention. At 202, a reroute region is defined around an initial flight path for the aircraft. The reroute region provides extreme boundaries for an optimal flight path, such that all points outside of the reroute region have an infinite cost. The reroute region can be defined according to time constraints, fuel constrains, political boundaries, and geographical features within the region of interest.

At 204, a plurality of subregions are defined within the reroute region. Each of the plurality of subregions represent one of a plurality of representative times at which the airplane is expected to arrive at an associated location on the initial flight path. Essentially, each subregion can be thought of representing one time period in the total time taken to pass through the region of interest. In one implementation, subregions are defined as overlapping, such that at least one region of overlap is created is created having at least two associated representative times.

At 206, the position of at least one threat is predicted at each of the plurality of representative times. For example, the position of a given threat at a given time can be determined from the direction of travel of the threat, the known capabilities of the threat, and geographical features in the region of interest. In one implementation, the prediction of the threat position can a probability region encompassing all locations within the region of interest in which the likelihood of the threat being present exceeds a threshold value. Alternatively, multiple probability regions can be established, with a first probability region encompassing all locations within the region of interest in which the likelihood of the threat being present exceeds a first threshold value, a second probability region within the region of interest in which the likelihood of the threat being present exceeds a second threshold value, and so forth. It will be appreciated that the various probability regions can overlap or even entirely subsume one another, such that, for example, some or all points in the first probability region are also in the second probability region.

At 208, a cost is assigned to each cell in each subregion according to the predicted position of the at least one threat source at the representative time associated with the subregion. In other words, only the positions which the threat could assume at the representative time for a given subregion are considered in calculating costs for cells within the subregion. There can be one or more known effective ranges associated with a given threat at which the aircraft is at risk of significant damage from the threat, and at least one of these ranges can be utilized to assign a cost to a given cell within a subregion according to the predicted position of the threat and the known effective range. For example, every point in the subregion within an effective range of the defined probability region, representing an area in which the threat has a likelihood above a threshold value of being present can be assigned a particular cost value. Alternatively, every point in a the subregion within an effective range of a first probability region, representing an area in which the threat has a likelihood above a first threshold value of being present, can be assigned a first cost while every point in the subregion within an effective range of a second probability region, representing an area in which the threat has a likelihood above a second threshold value of being present, can be assigned a second cost.

At 210, an optimal path is determined as a path through the reroute region from a starting location to an ending location having a lowest total cost. For example, the lowest cost path can be determined by any of a Dijkstra's algorithm, a Bellman-Ford algorithm, an A* search algorithm, a Floyd-Warshall algorithm, or an algorithm based on perturbation theory. In one implementation, the optimal flight plan is constrained such that the optimal path must pass through each of the plurality of subregions.

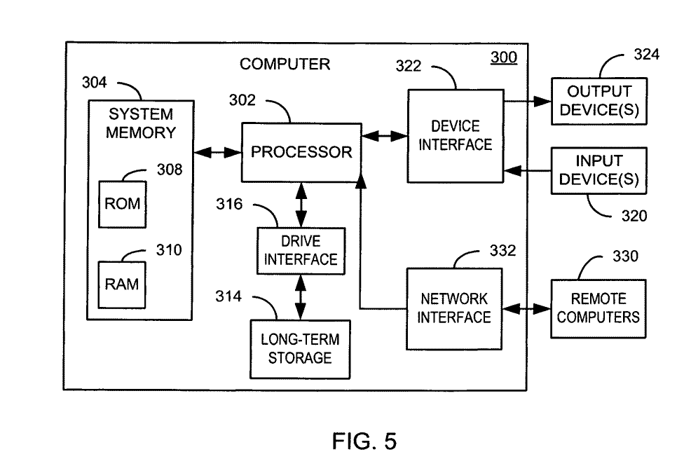

FIG. 5 illustrates a computer system 300 that can be employed to implement systems and methods described herein, such as based on computer executable instructions running on the computer system. The computer system 350 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 350. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data.

A user may enter commands and information into the computer system 300 through one or more input devices 320, such as a keyboard or a pointing device (e.g., a mouse). These and other input devices are often connected to the processor 302 through a device interface 322. For example, the input devices can be connected to the system bus by one or more a parallel port, a serial port or a universal serial bus (USB). One or more output device(s) 324, such as a visual display device or printer, can also be connected to the processor 302 via the device interface 322.

The computer system 300 may operate in a networked environment using logical connections (e.g., a local area network (LAN) or wide area network (WAN) to one or more remote computers 330. A given remote computer 330 may be a workstation, a computer system, a router, a peer device or other common network node, and typically includes many or all of the elements described relative to the computer system 300. The computer system 300 can communicate with the remote computers 330 via a network interface 332, such as a wired or wireless network interface card or modem. In a networked environment, application programs and program data depicted relative to the computer system 300, or portions thereof, may be stored in memory associated with the remote computers 330.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. A method for determining an optimal flight path for an aircraft through a region of interest, comprising:
defining a reroute region, which provides extreme boundaries for an optimal flight path, around an initial flight path for the aircraft;
defining a plurality of subregions within the reroute region, each of the plurality of subregions representing one of a plurality of representative times at which the airplane is expected to arrive at an associated location on the initial flight path;
predicting the position of at least one threat at each of the plurality of representative times;
assigning a cost to each cell in each subregion according to the predicted position of the at least one threat source at the representative time associated with the subregion; and
determining the optimal path as a path through the reroute region having a lowest total cost.

2. The method of claim 1, wherein determining the optimal path comprises determining a path having a lowest total cost that passes through each of the plurality of subregions.

3. The method of claim 1, wherein defining the plurality of subregions comprises defining a plurality of overlapping subregions within the reroute region, such that at least one region of overlap is created is created having at least two associated representative times.

4. The method of claim 1, wherein predicting the positions of at least one threat source comprises generating a probability region within the region of interest in which the likelihood of the threat being present exceeds a threshold value.

5. The method of claim 4, wherein assigning a cost to a given cell comprises adding a cost to the cell if the cell is within an effective range of the threat of any point in the probability region.

6. The method of claim 1, wherein predicting the positions of at least one threat source comprises generating a first probability region within the region of interest in which the likelihood of the threat being present exceeds a first threshold value and a second probability region within the region of interest in which the likelihood of the threat being present exceeds a second threshold value and assigning a cost to a given cell comprises adding a first cost to the cell if the cell is within an effective range of the threat of any point in the first probability region, and a second cost if the cell is within the effective range of the second probability region.

7. The method of claim 1, wherein predicting the position of at least one threat at each of the plurality of representative times comprises predicting the position of the threat at each representative time according to the direction of travel of the threat, the known capabilities of the threat, and at least one geographical feature in the region of interest.

8. The method of claim 1, wherein assigning a cost to each cell in each subregion further comprises assigning a cost to each cell according to nearby geographical features.

9. The method of claim 1, wherein defining a reroute region around an initial flight path for the aircraft comprises defining the reroute region according to at least one of time constraints, fuel constrains, political boundaries, and geographical features within the region of interest.

10. A computer readable medium, storing executable instructions for determining an optimal flight path for an aircraft through a region of interest, such that when provided to and executed by a computer processor, the executable instructions are configured to perform the following functions:
defining a reroute region, which provides extreme boundaries for an optimal flight path, around an initial flight path for the aircraft;
defining a plurality of subregions within the reroute region, each of the plurality of subregions representing one of a plurality of representative times at which the airplane is expected to arrive at an associated location on the initial flight path;
predicting the position of at least one threat at each of the plurality of representative times;
assigning a cost to each cell in each subregion according to the predicted position of the at least one threat source at the representative time associated with the subregion; and
determining the optimal path as a path through the reroute region passing through each of the plurality of subregions that has a lowest total cost.

11. The computer program product of claim 10, the executable instructions being configured such that predicting the positions of at least one threat source comprises generating a probability region within the region of interest in which the likelihood of the threat being present exceeds a threshold value.

12. The computer program product of claim 11, the executable instructions being configured such that assigning a cost to a given cell comprises adding a cost to the cell if the cell is within an effective range of the threat of any point in the probability region.

13. The computer program product of claim 10, the executable instructions being configured such that predicting the positions of at least one threat source comprises generating a first probability region within the region of interest in which the likelihood of the threat being present exceeds a first threshold value and a second probability region within the region of interest in which the likelihood of the threat being present exceeds a second threshold value, and assigning a cost to a given cell comprises adding a first cost to the cell if the cell is within an effective range of the threat of any point in the first probability region, and a second cost if the cell is within the effective range of the second probability region.

14. The computer program product of claim 10, the executable instructions being configured such that predicting the position of at least one threat at each of the plurality of representative times comprises predicting the position of the threat at each representative time according to the direction of travel of the threat, the known capabilities of the threat, and at least one geographical feature in the region of interest.

15. A system for determining an optimal flight path for an aircraft through a region of interest, comprising:
a map initialization component configured to define a reroute region, which provides extreme boundaries for an optimal flight path, around an initial flight path for the aircraft and a plurality of subregions within the reroute region, each of the plurality of subregions representing one of a plurality of representative times at which the airplane is expected to arrive at an associated location on the initial flight path;
a threat prediction component configured to predict the position of at least one threat at each of the plurality of representative times;
a cost mapping component configured to assign a cost to each cell in each subregion according to the predicted position of the at least one threat source at the representative time associated with the subregion and at least one geographical feature of the region of interest; and
a path optimization component configured to determine the optimal path as a path through the reroute region having a lowest total cost.

16. The system of claim 15, the path optimization component being configured to determine a path having a lowest total cost that passes through each of the plurality of subregions.

17. The system of claim 15, the map initialization component being configured to define a plurality of overlapping subregions within the reroute region, such that at least one region of overlap is created is created having at least two associated representative times.

18. The system of claim 15, the threat prediction component being configured to generate a probability region within the region of interest in which the likelihood of the threat being present exceeds a threshold value.

19. The system of claim 18, the cost mapping component being configured to retrieve a range associated with one of the at least one threat source, and add a cost to a cell if the cell is within the retrieved range of any point in the probability region.

20. The system of claim 15, each of the threat prediction component, the cost mapping component, and the path optimization component being implemented on the aircraft.
